(19) United States
(12) Patent Application Publication
(10) Pub. No.: US 2007/0204402 A1
(43) Pub. Date: Sep. 6, 2007

(54) Infant support and development pillow

(76) Inventors: Emily Harris, Taylor Ridge, IL (US); Karen Hughes, Milan, IL (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 11/368,988

(22) Filed: Mar. 6, 2006

(51) Int. Cl. A61G 9/00; A47D 13/00

(52) U.S. Cl. 5/655

(57) ABSTRACT

A circular infant protection and development pillow for protecting the head of an infant that is learning to sit up. The infant protection and development pillow assists in the development of the infant's back muscles which are not yet strong enough to independently support the infant while providing protection for the infant's head. The lower interior portion of the pillow allows the infant to sit within the pillow which fully surrounds the sitting infant. The upper portion of the pillow provides a soft but supportive continuously curved surface which in combination with an encircling inner seat pocket and inner seat area allow for variable positioning of the infant. The lower interior portion of the pillow is padded for the sitting infant's comfort and protection. The internal cushion portion of the pillow may be made of soft yet supportive material including foam rubber. The exterior cover of the pillow is of a one-piece construction and may be removed for washing or cleaning. The exterior cover of the pillow may be made from materials which resist germ infection and or transmission. The exterior surface of the pillow cover may include contrasting surface areas to stimulate improved cognitive development.

### FIELD OF THE INVENTION

The present invention relates to an infant sitting support device that allows an infant to sit alone safely and comfortably during those development stages when the infant is not yet capable of sitting erect. More specifically, the present invention promotes development of the infant's back musculature while protecting the infant in the event the infant falls over from a sitting position.

### CROSS REFERENCE TO RELATED APPLICATIONS (Not applicable)

None

### STATEMENT REGARDING FEDERALLY SPONSORED RESEARCH OR DEVELOPMENT

No federal funds were used to develop or create the invention disclosed and described in the patent application.

### BACKGROUND OF THE INVENTION

An infant sitting support and development pillow for protecting the head of an infant that is trying to sit up but is not yet strong enough is claimed and disclosed. A circular support cushion having a padded bottom is configured in combination with a removable cover to allow engagement with the buttocks, legs and feet of a sitting infant so that the infant is surrounded by a pillow which is soft yet supportive and covered by a removable exterior cover. The circular support cushion provides back and head support for a reclining or lounging infant. The pillow is configured so that when an infant falls, its head falls upon the soft, resilient upper portion of the circular support cushion.

### SUMMARY OF THE PRIOR ART

The prior art teaches numerous functional devices for an infant which include inflatable cribs, bassinets, pillows, bean bag chairs, etc. Although these devices are very useful in their own right, they fail to protect the infant and assist with the general development of the infant.

As is now recognized, between the ages of two and nine months, most infants are learning how to sit. During this time period, as the infant is learning how to sit, the infant's lower back muscles are not strong enough for independent support. As a consequence, when the infant independently attempts to sit up, the infant typically falls over, potentially banging its head in the process. The harder the surface contacted by the infant's head, the greater the potential damage. At a minimum, tumbles onto a hard surface may scare an infant and dampen its motivation to perfect its sitting skills. More importantly, the falls can result in minor injury to the infant such as minor head bruises. Also, the falls usually result in frustration for the infant, which is usually accompanied by tears that can be stopped only by attention from an adult. Placing a convenient pillow behind the infant might prevent a backward fall but other falls are almost inevitable.

Generally, therefore, attending to an infant who wants to sit alone, but cannot as yet do so with confidence, requires nearly a full-time effort.

U.S. Pat. No. 4,980,937 issued to Mason et al. attempts to address this problem by focusing solely on the protection aspect of the problem. As described in Mason, the infant is positioned within a bolster which essentially surrounds the infant. As described and disclosed the infant's lower back is fully supported by the bolster and the infant is effectively ensconced in the padded bolster. An infant positioned within the bolster to sit upright does not develop the stronger muscles necessary to sit independently. Also as described by Mason, the positioning of the infant's legs is unnatural. The legs of an infant between two months and nine months of age naturally tend to splay open i.e. the infant's legs are not straight out from the infant as disclosed.¹ The unnatural positioning of Mason results in an uncomfortable infant, naturally limiting the time an infant would spend in the device of Mason. The confining nature structure of Mason restricts the infant's movement, ability to reach nearby toys and does not allow for repositioning.
¹ Neediman, Robert, M. D., F.A.A.P. stating that “by five to six months, she balances (an infant) in a sitting position for a few moments, but you have to prop her up with her legs in front, knees bent, to provide a wide base, and brace her arms on her thighs.” www.drspock.com/article/0,1510.4873.html

Additionally, Mason goes on to describe numerous devices which are found in the prior art and directed towards the comfort of the child during infancy. They do not, however, provide support during this critical stage of development nor assist with independent muscular development. Mason and the patents recited therein are hereby incorporated by reference.

The prior art also fails to address several other needs for infants in this stage of development which are visual capacity and the sanitary conditions of the pillows. Infants between the ages of two and nine months are growing rapidly and every situation presents an opportunity to stimulate their facilities, including their vision and cognitive capabilities. The prior art does not teach an infant support system that also stimulates cognitive development.

Infant development is also accompanied by a general curiosity which is many times expressed orally i.e. babies like to reach and touch objects, followed by tasting what as been touched. Additionally, babies of this age have a natural tendency to salivate, drool and or spit-up. This material is bound to accumulate on any pillow in contact with the infant. The prior art does not teach an infant protection and development system that addresses this problem to provide improved hygienic properties through either simple method to remove the pillow cover for cleaning or pillow covers composed of germ resistance materials.

### SUMMARY OF THE INVENTION

An infant during the early stages of learning to sit independently typically falls forward more than back because of undeveloped lower back muscles. The present art as disclosed and described provides an infant protection and development device to assist with infant independence and protection during this period. As disclosed, the infant may comfortably bend its legs at the knees and hips so that they splay out. At this stage of development, the splaying out of the legs is natural for the infant so this position is of course more comfortable for the infant. Additionally, an infant having its legs splayed out provides a broader base to support itself, thereby further promoting stabilization when sitting up. An alternative embodiment of the present art promotes further cognitive development of the infant thus visual stimulation. As described the present art promotes hygiene and reduces germ transmission through a removable and washable one-piece cover design having a circumferential Velcro flap for detachment and removal. Another embodiment improves upon hygiene and inhibits germ transmission through the use of improved materials.

The present art is composed of an upper support cushion attached to a lower support cushion to form an infant protection and development pillow having an inner seat area with a closed bottom and contacting sides with an open top. An infant may be placed upon the lower support pad in the inner seat area. When so placed, the upper support cushion surrounds the infant.

The lower support pad is composed of a lower seat cover which is generally circular and has a pocket to allow fitted engagement with a lower seat pad with said lower seat cover; around the circumference of the lower seat pad is a lower seating flap. Upon attachment of the lower support cushion to the upper support cushion at the lower seating flap, a inner seat pocket is formed between the lower interior surface of the upper support cushion and the upper interior periphery of the lower support pad.

In one embodiment of the invention, a substantially vertical lower support surface having a curved upper portion provides minimal support for the lower back of the infant thereby inducing the infant to move back and forth. The movement back and forth while in the seated position exercises the infant's major postural stabilizers which include the Psoas major, Psoas minor, Ililus, Quadratus Lumborum, Rectus Abdominus, Internal Oblique, External Oblique, Transversus Abdominus and Erector Spinae group. It is the movement back and forth that generates the exercising effect resulting in lower back musculature and spinal cord development. Another embodiment of the invention has a rounded upper cushion support tip to provide minimal contact and support to the infant's lower back. The area of contact vertical support surface and the infant is in close proximity to the infant's lumbar vertebrae region. A shock absorption pocket accentuates this process by allowing the infant adequate space to adjust or re-adjust position as its muscles either tire or grow stronger increasing the number of muscles worked as well increasing the density of the muscles exercised. The vertical support surface, which presented a relatively flat surface, transitions to the substantially horizontal outer cushion surface to provide a continuously curving surface. The outer cushion surface serves to protect the infant if it falls and also allows the infant to rest while sitting up. The soft rounded sides of the horizontal cushion surface, being slightly higher than the infant's mid-section, absorb the infant's fall thus protecting the infant. Thus, the outer support cushion vertical support surface and shock absorption pocket work in combination to provide a method for independent, protected and dynamic infant development.

Although the outer cushion surface may be made of any soft cloth like material such as cotton or a polyester blend, a further improved alternative incorporates an exterior surface designed to promote improved cognitive development. As designed, the surface has alternating light and dark contrasting surface areas which stimulate a focusing response by the infant thereby stimulating appropriate neural generative response which is believed to improve cognitive development.²
²See http://www.umassmed.edu/shriver/research/psychological/infantvision/milestones.cfm

In another alternative embodiment, which may be incorporated independently or separately from the above, the material used to cover the outer cushion would be selected from a group of materials having anti-bacterial and or germ resistance repelling or killing properties. Materials having these properties include products incorporating silver fiber technology such as the product marketed under the tradename ARGENT-X® or X-STATIC®. Silver is naturally antimicrobial, enabling X-STATIC® to safely inhibit the growth of odor causing bacteria and fungi. Silver also quickly neutralizes ammonia and denatured proteins, making X-STATIC® useful for anti-odor issues.

It is therefore a general object of the present invention to provide an infant development and protection cushion that is safe, secure, comfortable and portable.

It is another object of the present invention to provide an infant development and protection cushion as above that will be useful as a sitting support from the infant's first attempts to sit alone until his or her first attempts to crawl.

It is another object of the present invention to provide an infant sitting support as above that will promote development of the muscles in the lower back which are necessary for the infant to sit independently.

It is another object of the present invention to provide an infant sitting support as above having an outer surface pattern that will promote development of the infant's cognitive facilities.

It is another object of the present invention to provide an infant sitting support pillow as above with a cover having a one-piece construction that is removable and washable along a single horizontal circumferential seam.

It is another object of the present invention to provide an infant sitting support as above with a cover that will resist germ transmission and or has anti-bacterial properties thereby improving the infant's health and the health of those around the infant.

These and related objects are achieved through the use of the novel infant protection and development cushion device disclosed herein.

### DESCRIPTION OF THE DRAWINGS

FIG. 1 is a perspective view of one embodiment of the infant support and development pillow with a child sitting therein.

FIG. 2 is an expanded view of the infant support and development pillow shown at FIG. 1 highlighting the relationship between the infant's back and inner pillow.

FIG. 3 provides a cross-sectional view of the infant support and development pillow of one embodiment illustrating the appropriate dimensional relationship.

FIG. 4 is an exploded view of the primary elements comprising the infant protection and development device of the preferred embodiment of FIG. 1.

FIG. 5 is an alternative embodiment of the present invention with an expanded view of the infant protection and development device previously shown at FIG. 1 highlighting the relationship between the infant's back and the device.

FIG. 6 provides a cross-sectional view of the infant protection and development device of the alternative embodiment shown at FIG. 5 illustrating the appropriate dimensional relationship.

FIG. 7 provides an exploded view of the components comprising the infant support and development pillow.

### DETAILED DESCRIPTION—ELEMENT LISTING

| Element No. | Description |
|---|---|
| 1 | Infant support and development pillow |
| 2 | Circular support cushion |
| 3 | Removable cushion cover |
| 4 | Central opening |
| 5 | Padded seat |
| 6 | Lower inner sidewalls of inner seat area |
| 7 | Upper inner sidewalls of inner seat area |
| 8 | Lower outside of circular support cushion |
| 9 | Upper outside of circular support cushion |
| 10 | Lower seating flap |
| 11 | Circumferential outer seam |
| 12 | Circumferential inner seam |
| 13 | Lower seating flap opening |
| 14 | Seating pad |
| 15 | Detachable securement means |
| 16 | Contrast area - dark |
| 17 | Contrast area - light |
| 18 | Lower seating flap zipper |
| 19 | Support gap |
| 20 | Infant |
| 21 | Infant posterior |
| 22 | Infant lower spinal area (back) |
| 23 | Substantially vertical inner surface |
| 24 | Pattern shape for the top portion of cover |
| 25 | Pattern shape for the bottom portion of cover |
| 26 | Pattern shape for the lower seating flap |
| 27 | Pattern for circumferential inner seam |
| 28 | Pattern for circumferential outer seam |

### DETAILED DESCRIPTION

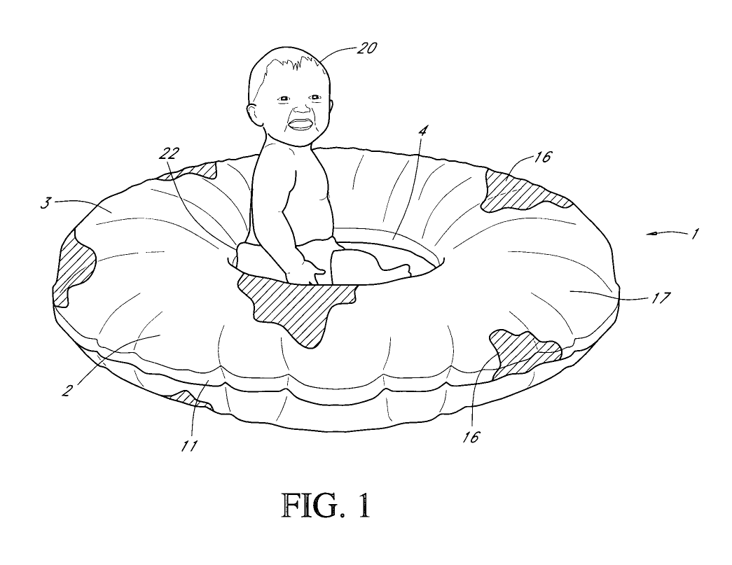

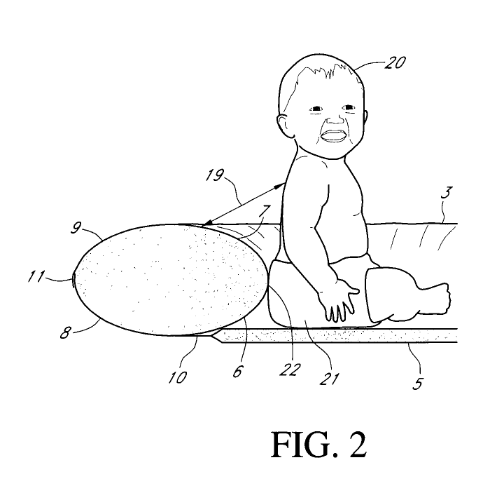

FIG. 1 illustrates a perspective view of the infant support and development device 1 of the preferred embodiment with an infant 20 sitting therein. An infant 20 during the early stages of learning to sit independently typically falls forward more than back because of undeveloped lower back muscles. As shown in FIG. 1 and FIG. 2, the infant support and development pillow 1 comprises a circular support cushion 2 having sides surrounding a central opening 4. A padded seat 5 (FIG. 2) located in the central opening 4 of said circular support cushion 2 is shown wherein the sides of the circular support cushion 3 are sized for minimal contact with the lower spinal area of an infant 22 placed in the central opening upon the padded seat 5. A removable cover 3 surrounds the circular support cushion 2 and the padded seat 5, as shown in FIG. 1, wherein the removable cover 3 has a set of seams, 11 and 12, respectively. A first seam 11 is located on the outside circumference of the circular support cushion 2. A second seam, 12, is located on the inside circumference of the circular support cushion 2. At least one of the two seams may be opened, without repair, to allow removal of said circular support cushion 2. Although not shown, it should be apparent to those practiced in the arts that as shown at FIG. 1, the circumferential seams, 11 and 12, in combination with Velcro attachment means 15 allow for easy detachment and removal of the cushion cover 3 from circular cushion 2 for cleaning of the cushion cover 3. The embodiment as illustrated at FIG. 1 shows that one of the two circumferential seams, in this case the outer circumferential seam 11, must use some detachable securement means 15, such as Velcro, for securement. Alternatively, permanent means, such as stitched threading, may be used for one of the two other circumferential seams (as shown, inner circumferential seam 12).

FIG. 1 also shows an alternative embodiment of the present art for the stimulation of improved cognitive development. Dark surfaces 16 in combination with light surfaces 17 have been shown to promote improved cognitive development. As designed, the combination of alternating dark surfaces 16 and light surfaces 17 stimulate a focusing response by the infant thereby stimulating appropriate neural generative response which improves cognitive development.³ As shown in FIG. 1 the cushion cover 3 may be constructed with dark and light contrast areas, 16 and 17, respectively. The cushion cover 3 may be further improved in an alternative embodiment by using materials that resist or inhibit germ transmission and or infection. (Not shown)
³http://www.unassmed.edu/shriver/research/psychological/infantvision/milestones.cfm

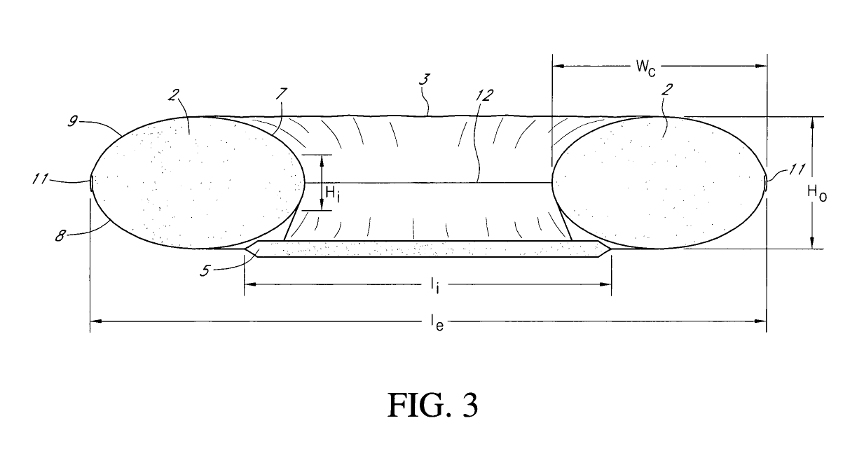

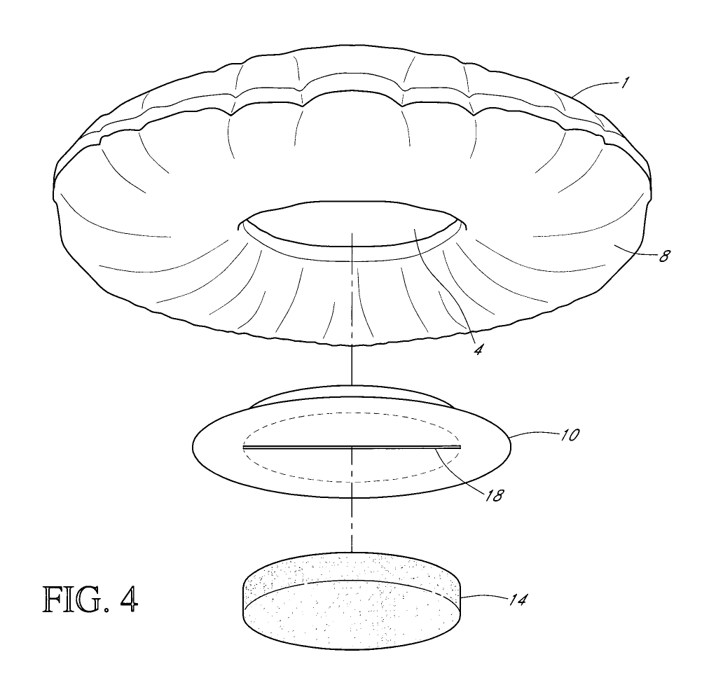

As better shown in FIG. 2 and FIG. 3, the infant support and development cushion 1 may present only a forward circular edge for contact with the infant's lower back. The lower and upper inner sidewalls of the circular support cushion, 6 and 7, respectively, forming the central opening 4 and surrounding the padded seat 5 contact the infant's lower spine 22 only at the inner most radius of the circular support cushion 2. The infant's posterior 21 is then supported by padded seat 5 which is comprised of a seating pad 14 inserted into the lower seating flap 10. (See FIG. 4)

Limiting the area in contact with the infant's lower back 22 creates a support gap 19 which increases the potential for natural movement of the infant 20 while positioned in central opening 4. The resulting back and forth movement of the infant's back 22 at 2 exercises the infant's major postural stabilizers which include the Psoas major, Psoas minor, Ililus, Quadratus Lumborum, Rectus Abdominus, Internal Oblique, External Oblique, Transversus Abdominus and Erector Spinae group. It is the movement back and forth that generates the exercising effect resulting in muscular and spinal development while still providing a cushion for the skull of the infant 22, should it fall forward or backward. Additionally, the upper inner sidewalls of the inner seat area 6 and the upper outside surface 9 of the circular support cushion 2 provide sufficient surface area for the infant to safely recline against when the infant grows tired of sitting up.

Generally, as shown in FIG. 3, the interior length (lᵢ) of the lower seating flap ranges may range from ten to twenty inches. In the preferred embodiment, the interior length is sixteen inches. The exterior length (lₑ) is thirty to forty-four inches. In the preferred embodiment, the exterior length is fifty-six inches. The overall height (Hₒ) of the circular cushion 2 may range from eight to sixteen inches. In the preferred embodiment, the height of the circular cushion is twelve inches. The cross-sectional (W_{c}) of the cushion is sixteen inches.

FIG. 4 provides an exploded perspective view of the components comprising the central opening 4 and padded seat 5 of the removable cushion cover 3. The padded seat 5 is fixed within the central opening by the lower seating flap 10 which is sewn or fastened to the lower inner sidewall 6 at numerous points surrounding the central opening 4. The preferred point of affixation between the outer perimeter of the lower seating flap 10 and the lower inner sidewall 6 is the transition point between the lower inner sidewall 6 and the lower outside surface of the circular cushion 8. The lower seating flap 10 has a zippered opening which allows removal of seating pad 14 from cushion cover 3 for washing and or cleaning of cover 3 or seating pad 14.

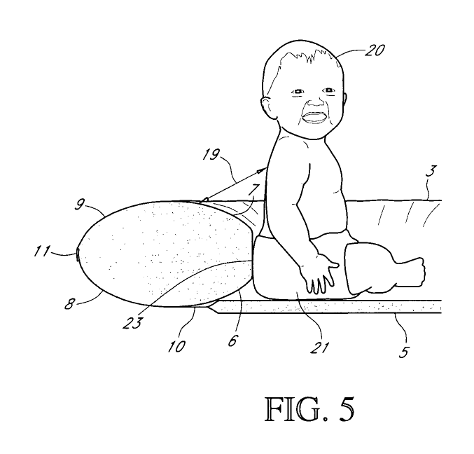

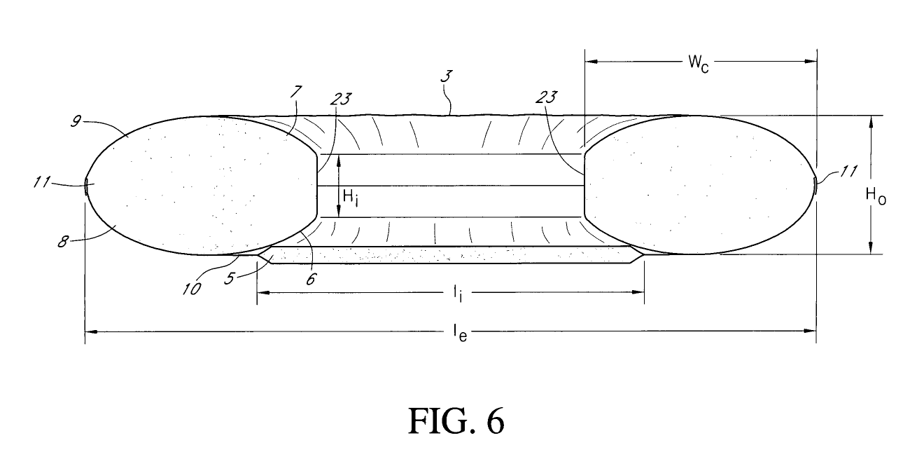

FIGS. 5 and 6 illustrates another embodiment of the present invention wherein the circular support cushion pine has lower and upper inner sidewalls which meet at a substantially vertical inner wall 23. This substantially vertical inner wall 23 presents a continuous inner surface for minimal contact with the lower spinal area of the infant 22. For comfort, the height (Hᵢ) of the vertical inner wall 23 should be at least one-quarter of the height of the circular cushion 2 (Hₒ) but not more than one-half the height of the circular cushion 2. The dimensions for this embodiment are substantially similar to the embodiment shown in FIG. 3 and described therein.

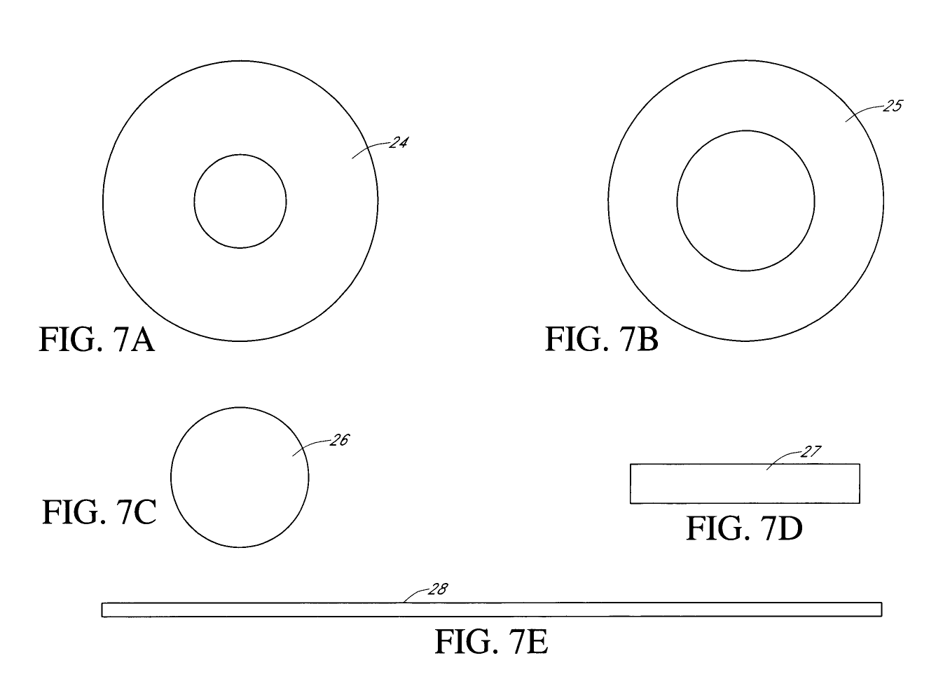

FIGS. 7A-7E present a detailed view of the basic components combined to construct the cover of the present invention. FIG. 7A illustrates the pattern shape 24 for the top of the cover 3. FIG. 7B illustrates the pattern shape 25 for the bottom of the cover 3. FIG. 7C illustrates the pattern shape 26 for the lower seating flap 10. FIG. 7D illustrates the pattern shape 27 for the circumferential inner seam 12 and FIG. 7E illustrates the pattern shape 28 for the circumferential outer seam.

While the invention has been described with reference to preferred embodiments, variations or modifications would be apparent to one of ordinary skill in the art without departing from the scope of the invention. Consequently, the appended claims should not be limited to their literal terms, but should be broadly construed in accordance with the scope of the invention, as described above.

What is claimed is:

1) An infant support and development pillow comprising:
a) A circular support cushion having sides surrounding a central opening;
b) A padded seat located in the central opening of said circular support cushion wherein said sides of said circular support cushion may contact the lower spinal area of an infant placed in said central opening upon said padded seat; and,
c) A cover to surround said circular support cushion and said padded seat, said cover further comprising a first seam located on the inside circumference of said circular support cushion and a second seam located on the outside circumference of said circular support cushion wherein at least one of said seams may be opened, without repair, to allow removal of said circular support cushion.

2) The apparatus of claim 1 wherein said circular support cushion sides contact the lower back of said infant and padded seat supports the infant's buttock, legs and feet.

3) The apparatus of claim 2 wherein said central opening is sized to allow the legs of said infant to naturally splay.

4) The apparatus of claim 3 wherein said circular support cushion is made of a soft yet supportive material, thereby protecting said infant's head during a fall.

5) The apparatus of claim 4 wherein said infant is approximately a three to nine month old infant.

6) The apparatus of claim 1 wherein said first and second seams are located directly apposite.

7) The apparatus of claim 6 wherein said first and second seams are located at the midway point of said circular support cushion sides.

8) The apparatus of claim 7 wherein at least one of said seams has Velcro affixed between the edges of said seams for securement of said edges.

9) The apparatus of claim 1 wherein the size of said central opening and said circular support cushion sides are selected to allow the infant to move back and forth while in the seated position to exercise the infant's lower back muscles during use.

10) The apparatus of claim 9 wherein said lower back muscles include the major postural stabilizers defined as the Psoas major, Psoas minor, Ililus, Quadratus Lumborum, Rectus Abdominus, Internal Oblique, External Oblique, Transversus Abdominus and Erector Spinae group.

11) The apparatus of claim 7 wherein the size of said central opening and said circular support cushion sides are selected to allow the infant to move back and forth while in the seated position to exercise the infant's lower back muscles.

12) The apparatus of claim 11 wherein said infant is approximately a three to nine month old infant.

13) The apparatus of claim 1 wherein the cover is comprised of a material selected from the group consisting of cotton, polyester, nylon, materials incorporating silver fiber and combinations thereof to inhibit odor and bacteria.

14) The apparatus of claim 2 wherein the cover is comprised of a material selected from the group consisting of cotton, polyester, nylon, materials incorporating silver fiber and combinations thereof to inhibit odor and bacteria.

15) The apparatus claim 7 wherein the cover is comprised of a material selected from the group consisting of cotton, polyester, nylon, materials incorporating silver fiber and combinations thereof to inhibit odor and bacteria.

16) The apparatus of claim 8 wherein the cover is comprised of a material selected from the group consisting of cotton, polyester, nylon, materials incorporating silver fiber and combinations thereof to inhibit odor and bacteria.

17) The apparatus of claim 10 wherein the cover is comprised of a material selected from the group consisting of cotton, polyester, nylon, materials incorporating silver fiber and combinations thereof to inhibit odor and bacteria.

18) The apparatus of claim 1 wherein said circular cushion inner sides are substantially vertical and form a flat surface to contact said infant's lower back.

19) The apparatus of claim 2 wherein said circular cushion inner sides are substantially vertical and form a flat surface to contact said infant's lower back.

20) The apparatus of claim 7 wherein said circular cushion inner sides are substantially vertical and form a flat surface to contact said infant's lower back.

21) The apparatus of claim 8 wherein said circular cushion inner sides are substantially vertical and form a flat surface to contact said infant's lower back.

22) The apparatus of claim 10 wherein said circular cushion inner sides are substantially vertical and form a flat surface to contact said infant's lower back.

23) The apparatus of claim 1 wherein said specific interior width is in a range of 10 to 16 inches.

24) The apparatus of claim 1 wherein said specific interior length is in a range of 14 to 20 inches.

25) The apparatus of claim 10 wherein said specific interior width is in a range of 10 to 16 inches.

26) The apparatus of claim 10 wherein said specific interior length is in a range of 14 to 20 inches.

27) The apparatus of claim 13 wherein said specific interior width is in a range of 10 to 16 inches.

28) The apparatus of claim 14 wherein said specific interior length is in a range of 14 to 20 inches.

29) The apparatus of claim 21 wherein said specific interior width is in a range of 10 to 16 inches.

30) The apparatus of claim 22 wherein said specific interior length is in a range of 14 to 20 inches.

31) The apparatus of claim 2 wherein the pattern of said cover is selected to have areas of contrast to improve the visual development of said infant.

32) The apparatus of claim 8 wherein the pattern of said cover is selected to have areas of contrast to improve the visual development of said infant.

33) The apparatus of claim 12 wherein the pattern of said cover is selected to have areas of contrast to improve the visual development of said infant.

34) The apparatus of claim 29 wherein the pattern of said cover is selected to have areas of contrast to improve the visual development of said infant.

35) The apparatus of claim 30 wherein the pattern of said cover is selected to have areas of contrast to improve the visual development of said infant.
